(19) United States
(12) Patent Application Publication
(10) Pub. No.: US 2025/0118466 A1
(43) Pub. Date: Apr. 10, 2025

(54) RARE-EARTH BONDED MAGNET COMPOUND AND METHOD FOR PRODUCING RARE-EARTH BONDED MAGNET USING SAME

(71) Applicant: DAIDO STEEL CO., LTD., Nagoya-shi (JP)

(72) Inventors: Teruki USUDA, Nagoya-shi (JP); Yusuke TOZAWA, Nagoya-shi (JP); Asako KAMIMOTO, Nagoya-shi (JP); Issei FUKUZAKI, Nagoya-shi (JP); Takayoshi OKAMOTO, Nagoya-shi (JP); Teruhisa FURUYA, Nagoya-shi (JP)

(21) Appl. No.: 18/900,673

(22) Filed: Sep. 28, 2024

(30) Foreign Application Priority Data
Oct. 4, 2023 (JP) 2023-173257
Jul. 22, 2024 (JP) 2024-117089

(51) Int. Cl. H01F 1/059; B22F 1/052; B22F 3/22; H01F 41/02

(52) U.S. Cl. CPC H01F 1/059; B22F 1/052; H01F 41/0266; B22F 3/225; B22F 2301/45; B22F 2304/10

(57) ABSTRACT

The present invention relates to a rare-earth bonded magnet compound, the compound including: a rare-earth magnet powder that includes a coarse powder and a fine powder; and a resin binder, in which the rare-earth bonded magnet compound is obtained by kneading the rare-earth magnet powder and the resin binder, the rare-earth magnet powder is obtained by mixing the coarse powder and the fine powder, the coarse powder has a D50 of 240 μm or more and less than 380 μm, the fine powder has a D50 of 35 μm or less, and the rare-earth magnet powder has a D90/D10, which is a ratio of D90 to D10 in a particle size distribution of the entire rare-earth magnet powder, of 28 or more and 37 or less.

### CROSS-REFERENCE TO RELATED APPLICATIONS

This application is based on and claims priority under 35 USC 119 from Japanese Patent Applications No. 2023-173257 filed on Oct. 4, 2023 and No. 2024-117089 filed on Jul. 22, 2024, the contents of which are incorporated herein by reference.

### TECHNICAL FIELD

The present invention relates to a rare-earth bonded magnet compound obtained by kneading a binder and a rare-earth magnet powder containing a rare earth element as a main constituent element, and a method for producing a rare-earth bonded magnet using the compound. Examples of the rare earth magnet to be used in the present invention include an RFeN-based rare earth magnet containing a rare earth element (R), iron (Fe), and nitrogen (N) as main constituent elements, an RFe-based rare earth magnet containing a rare earth element and iron as main constituent elements, an RFeB-based rare earth magnet containing a rare earth element, iron, and boron (B) as main constituent elements, and an RCo-based (RCo₅-based, R₂Co₁₇-based) rare earth magnet containing a rare earth element and cobalt (Co) as main constituent elements.

### BACKGROUND ART

A bonded magnet is generally produced by preparing a bonded magnet compound (hereinafter, abbreviated as “compound”) by kneading a magnet powder and a resin binder, that is, kneading a magnet powder and a resin binder in a state where the magnet powder and the resin binder are heated to a temperature higher than a melting point of the binder after the two are mixed or while mixing the two, heating the compound to melt the binder, and solidifying the compound in a mold. Examples of the molding method includes compression molding, extrusion molding, and injection molding. Among them, the injection molding has an advantage of allowing a high degree of freedom in a shape of the bonded magnet that can be produced.

In the case where a bonded magnet is produced by injection molding, if the flowability of the compound when the compound is injected into the mold is low, the compound does not spread over the entire mold, and a bonded magnet having a predetermined shape cannot be obtained. Therefore, a compound having high flowability is required.

Patent Literature 1 describes that a rare-earth bonded magnet is produced by using a rare-earth bonded magnet compound obtained by kneading an RFeN-based rare-earth magnet powder, a binder, and a coupling agent. In general, the coupling agent is chemically bonded to molecules of the binder while adhering to surfaces of particles of the magnet powder in a state where the binder is melted, and thus the coupling agent acts so that the particles of the magnet powder easily flow with the melted binder. Examples of the coupling agent include those made of various materials, and in Patent Literature 1, a silane coupling agent represented by a general formula R₍₄₋ₙ₎—Si-X₍ₙ₎ where R represents one or two or more organic groups having a hydrocarbon group or a functional group, X represents a hydrolyzable group such as an alkoxy group or a glycol group, and n represents an integer within a range of 1 to 3 is used.
Patent Literature 1: JP2016-092262A
Non Patent Literature 1: Akinari Minegishi “Fundamentals of Slurry Rheology: Relationship between Particle Size, Particle Shape, and Zeta Potential” [online], Feb. 19, 2018, Spectris Co., Ltd., [Search on Jul. 5, 2023], Internet <URL: https://www.materials-talks.jp/files/20180226142620_0.pdf>

### SUMMARY OF INVENTION

The flowability of the compound varies depending on not only the presence or absence of the coupling agent and the type of the coupling agent but also various conditions. In some cases, even though the coupling agent is added, the flowability of the compound may decrease. An object of the present invention is to provide a rare-earth bonded magnet compound having high flowability when a binder is molten regardless of the presence or absence of a coupling agent.

In order to solve the above problem, a rare-earth bonded magnet compound according to the present invention is a rare-earth bonded magnet compound obtained by kneading a rare-earth magnet powder and a resin binder, in which the rare-earth magnet powder is obtained by mixing a coarse powder having a D50 of 240 μm or more and less than 380 μm and a fine powder having a D50 of 35 μm or less, and D90/D10, which is a ratio of D90 to D10 in a particle size distribution of the entire rare-earth magnet powder, is 28 or more and 37 or less.

In the present invention, “D50” refers to a particle diameter at which a cumulative distribution relating to the particle diameter of a powder measured by the laser diffraction/scattering method using a particle size distribution analyzer (MT3300EX manufactured by MicrotracBEL Corp.) is 50%. The cumulative distribution relating to the particle diameter of a powder indicates a proportion of the volume (which is proportional to weight) occupied by particles having a particle diameter smaller than a certain particle diameter in the entire powder. Similarly, “D90” and “D10” refer to particle diameters at which the cumulative distributions are 90% and 10%, respectively.

In the rare-earth bonded magnet compound according to the present invention, a mixture of a coarse powder and a fine powder each having the above range of D50 and different particle diameters is used as the rare-earth magnet powder. In general, it is known that, in a slurry obtained by mixing a powder and a liquid, when a powder containing particles having different particle diameters is used, the viscosity of the slurry is lower than that of a slurry including a powder made of particles having a uniform particle diameter (for example, see Non-Patent Literature 1). In the present invention, the coarse powder and the fine powder are mixed with each other, and then the D90/D10 of the entire rare-earth magnet powder after mixing is set to be 28 or more and 37 or less. Accordingly, the flowability of the rare-earth bonded magnet compound when the binder is melted can be higher than that in the case where a rare-earth magnet powder having another particle size distribution is used.

In the case where the D50 of the coarse powder is smaller than the above range or the D50 of the fine powder is larger than the above range, a difference between the particle diameters of the coarse powder and the fine powder is reduced, and the flowability of the rare-earth bonded magnet compound cannot be sufficiently increased. On the other hand, in the case where the D50 of the coarse powder is larger than the above range, the coarse particles are likely to aggregate in the rare-earth bonded magnet compound in which the binder is melted, and the flowability is lowered. The lower limit of the D50 of the fine powder is not particularly limited, but an excessively small D50 makes it difficult to produce the fine powder. Therefore, the D50 of the fine powder may be made small within a range in which production of the fine powder is possible.

In the rare-earth bonded magnet compound according to the present invention, a RFeN-based rare-earth magnet powder, a RFe-based rare-earth magnet powder, a RFeB-based rare-earth magnet powder, a RCo-based rare-earth magnet powder, or the like can be used as the rare-earth magnet powder. In particular, a SmFeN-based rare earth magnet in which the rare earth element R is Sm among the RFeN-based rare earth magnets has a small change in coercive force with respect to temperature and can be preferably used for a motor for driving an automatic vehicle whose temperature rises to about 130° C. during use, and therefore, the SmFeN-based rare-earth magnet powder can also be preferably used in the present invention.

In the rare-earth bonded magnet compound according to the present invention, the rare-earth magnet powder may be made of flat particles having a flat shape. Generally, a magnet compound in which a magnet powder is made of flat particles has lower flowability than a magnet compound in which a magnet powder is made of spherical particles, and is not suitable for use in molding such as injection molding. However, in the magnet compound according to the present invention, since the flowability can be increased by mixing the coarse powder and the fine powder, the magnet compound according to the present invention can be used for molding such as injection molding even when the magnet powder is made of flat particles. In the present invention, the “flat particle” refers to a particle in which a size in one direction perpendicular to a certain direction (thickness direction) is twice or more as large as the size of the particle in the thickness direction. The magnet powder made of such flat particles is obtained by, for example, dropping, onto a surface of a roll rotating at a high speed, molten metal obtained by melting an alloy which is a material of a rare earth magnet to prepare a ribbon-shaped alloy, and then pulverizing the ribbon-shaped alloy.

The rare-earth bonded magnet compound according to the present invention can be preferably used particularly for producing a rare-earth bonded magnet by injection molding because of high flowability thereof. In the injection molding, a thermoplastic resin is generally used as a binder, and therefore, the binder contained in the rare-earth bonded magnet compound according to the present invention is preferably a thermoplastic resin. However, the rare-earth bonded magnet compound according to the present invention may be used for producing a rare-earth bonded magnet by a method other than injection molding such as compression molding or extrusion molding, and in this case, a thermosetting resin binder may be used.

In the rare-earth bonded magnet compound according to the present invention, it is preferable that the binder has a viscosity of 25 Pa·s or less at a temperature of 310° C. The viscosity is measured according to ISO 11443 under conditions that a shear rate is 1000 sec⁻¹, a ratio L/D of a length L of a capillary to an inner diameter D thereof is 30/1 and a measurement time is 5 minutes). Accordingly, the flowability of the rare-earth bonded magnet compound when the binder is melted can be further increased. Examples of the material of the binder that satisfies such conditions include polyphenylene sulfide (PPS).

It is not necessary to add a coupling agent to the rare-earth bonded magnet compound according to the present invention. However, addition of a coupling agent to the rare-earth bonded magnet compound according to the present invention is allowed.

A method for producing a rare-earth bonded magnet according to the present invention, the method includes: preparing a rare-earth bonded magnet compound by kneading a rare-earth magnet powder and a binder (a compound preparing step), the rare-earth magnet powder being a mixture of a coarse powder having a D50 of 240 μm or more and less than 380 μm and a fine powder having a D50 of 35 μm or less, and the rare-earth magnet powder having a D90/D10, which is a ratio of D90 to D10 in a particle size distribution of the entire rare-earth magnet powder, of 28 or more and 37 or less; and melting the binder kneaded into the rare-earth bonded magnet compound and then injecting the rare-earth bonded magnet compound into a mold (an injection molding step).

According to the method for producing a rare-earth bonded magnet of the present invention, the flowability of the rare-earth bonded magnet compound in the injection molding step can be increased by using the rare-earth bonded magnet compound according to the present invention. Therefore, the rare-earth bonded magnet compound can be more reliably spread over the entire mold, and a bonded magnet having a predetermined shape can be more reliably obtained.

According to the present invention, it is possible to obtain a rare-earth bonded magnet compound having high flowability when a binder is melted.

### BRIEF DESCRIPTION OF DRAWINGS

FIGS. 1A to 1C are schematic views illustrating a method for producing a rare-earth bonded magnet compound according to an embodiment of the present invention.

FIG. 1D is a schematic view illustrating a method for producing a rare-earth bonded magnet using the rare-earth bonded magnet compound.

FIG. 2 is a graph showing an example of a cumulative distribution of particle diameters of a coarse powder and a fine powder contained in the rare-earth bonded magnet compound of the present embodiment.

FIG. 3 is a graph showing an example of a distribution of particle diameters of the coarse powder and the fine powder contained in the rare-earth bonded magnet compound of the present embodiment.

FIG. 4 is a graph showing an example of the cumulative distribution of the particle diameter of a rare-earth magnet powder contained in the rare-earth bonded magnet compound of the present embodiment.

FIG. 5 is a graph showing results of measuring the flowability of a plurality of rare-earth bonded magnet compounds of the present embodiment and the comparative example having different D90/D10 values of the contained rare-earth magnet powder.

### DESCRIPTION OF EMBODIMENTS

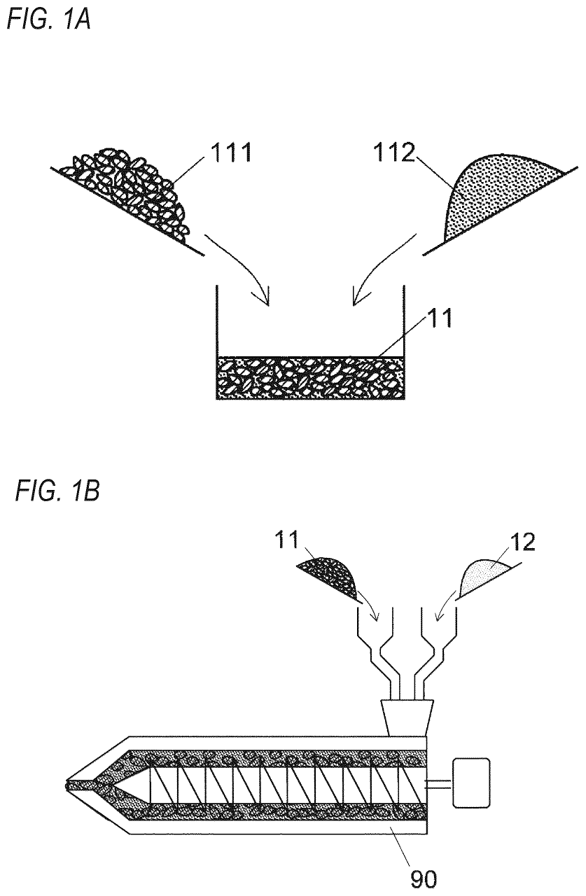

An embodiment of a rare-earth bonded magnet compound according to the present invention and an embodiment of a method for producing a rare-earth bonded magnet using the rare-earth bonded magnet compound will be described with reference to FIG. 1A to FIG. 5.

First, a rare-earth bonded magnet compound of the present embodiment will be described along with a method for producing the compound and a method for producing a rare-earth bonded magnet using the compound with reference to FIGS. 1A to 1D.

A rare-earth bonded magnet compound (hereinafter abbreviated as “compound”) 10 of the present embodiment is obtained by kneading a rare-earth magnet powder 11 and a binder 12 made of resin. Here, the rare-earth magnet powder 11 is obtained by mixing a rare earth magnet coarse powder (hereinafter abbreviated as “coarse powder”) 111 and a rare earth magnet fine powder (hereinafter abbreviated as “fine powder”) 112. FIGS. 1A to 1C shows an example in which the pellet-shaped compound 10 is prepared (FIG. 1C) in a procedure of preparing the rare-earth magnet powder 11 by mixing the coarse powder 111 and the fine powder 112 (FIG. 1A), and then kneading the rare-earth magnet powder 11 and the binder 12 by a kneader 90 (FIG. 1). Alternatively, the coarse powder 111, the fine powder 112, and the binder 12 may be mixed in advance and then fed into the kneader 90 and kneaded, or the coarse powder 111, the fine powder 112, and the binder 12 may be fed into the kneader 90 at the same time without being mixed in advance and then kneaded.

In general, examples of the resin include a thermoplastic resin and a thermosetting resin. A thermoplastic resin is generally used in injection molding, and therefore, it is also preferable to use a thermoplastic resin for the binder in the present embodiment. A thermosetting resin may be used for the binder in the case where molding is performed by compression molding, extrusion molding, or the like. As the thermoplastic resin of the binder 12 used in the compound 10 of the present embodiment, for example, polyphenylene sulfide (PPS), polyamide (PA), or the like can be used. Among these examples, PPS is preferably used from the viewpoint that the heat resistance of the rare-earth bonded magnet can be increased because PPS has high flowability and a high thermal deformation temperature. Since the binder 12, which is a thermoplastic resin, is a solid at room temperature, the binder 12 is mixed with the rare-earth magnet powder 11 after the binder 12 being powdered.

Both the coarse powder 111 and the fine powder 112 constituting the rare-earth magnet powder 11 are obtained by pulverizing an alloy body made of an alloy which is a material of the rare earth magnet. Examples of such alloys include RFeN-based alloys, RFe-based alloys, RFeB-based alloys, and RCo-based alloys. The RFeN-based alloy contains R (rare earth elements), Fe (iron), and N (nitrogen) as main constituent elements, and has a composition of R₂Fe₁₇Nₓ or RFe₇Nₓ obtained by introducing N into R₂Fe₁₇ or RFe₇. The type of R in the RFeN-based alloy is not limited, and Sm (samarium) is particularly preferably used. The RFe-based alloy contains R and Fe as main constituent elements and has a composition of R₂Fe₁₇ or RFe₇. The type of R in the RFe-based alloy is not limited, and Sm is particularly preferably used. The RFeB-based alloy contains R, Fe, and B (boron) as main constituent elements and has a composition of R₂Fe₁₄B. The type of R in the RFeB-based alloy is not limited, and Nd (neodymium) is particularly preferably used. The RCo-based alloy contains R and Co as main constituent elements and has a composition of RCo₅ or R₂Co₁₇. The type of R in the alloy of the RCo-based alloys is not limited, and Sm is particularly preferably used.

The alloy body of the rare earth magnet can be more preferably prepared by a molten metal quenching method. In the molten metal quenching method, a molten metal obtained by melting an alloy of a rare earth magnet is quenched by being dropped onto a surface of a roll rotating at a high speed, thereby preparing the alloy body. The alloy body prepared by this method has a ribbon shape. A powder made of flat particles having a flat shape is obtained by pulverizing the ribbon-shaped alloy body. The flat particles are generally less likely to flow together with a liquid having viscosity as compared with spherical particles. However, the coarse powder 111 and the fine powder 112 from the powder made of such flat particles are obtained as described below and the compound 10 includes the coarse powder 111, the fine powder 112, and the binder 12, and thus the flowability of the compound 10 when the contained binder 12 is melted can be increased.

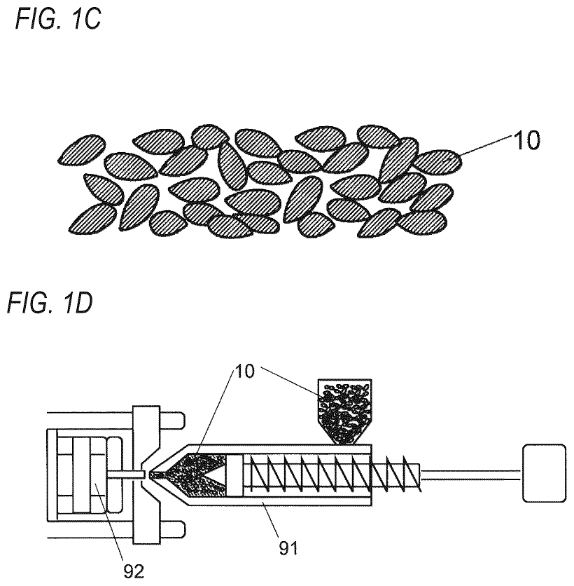

The coarse powder 111 having a D50 of 240 μm or more and less than 380 μm and the fine powder 112 having a D50 of 35 μm or less are obtained by setting different target particle sizes during pulverization of the alloy body or classifying the pulverized powder according to a particle diameter. Here, the D50 is a value also referred to as a “median”, and refers to a particle diameter at which a cumulative distribution relating to the particle diameter of the powder is 50%. The cumulative distribution relating to the particle diameter of the powder indicates a proportion of a volume (which is proportional to weight) occupied by particles having a diameter smaller than a certain particle diameter in the entire powder. FIG. 2 is a graph showing an example of a cumulative distribution of the coarse powder 111 and the fine powder 112, and the graph shows a position on a horizontal axis corresponding to the values of D50 of the coarse powder 111 and the fine powder 112 in this example.

Generally, the D50 of a powder can be measured by various methods, and it is known that the obtained values vary depending on the measurement method. In the present embodiment, the D50 of the coarse powder 111 and the fine powder 112 is a value measured by a laser diffraction/scattering method. When the D50 of the coarse powder 111 is too small, the difference in particle diameter between the coarse powder 111 and the fine powder 112 is reduced, and the effect of the present invention is not exhibited. When the D50 thereof is too large, the magnetic powder clogs a flow path during injection molding or during evaluation of flowability. Therefore, the D50 of the coarse powder 111 is 240 μm or more and less than 380 μm. The preferable range of the D50 of the coarse powder 111 is more than 250 μm and 370 μm or less. When the D50 of the fine powder 112 is too large, the difference in particle diameter between the fine powder 112 and the coarse powder 111 is reduced, and the effect of the present invention is not exhibited. Therefore, the D50 of the fine powder 112 is 35 μm or less. The lower limit of the D50 of the fine powder 112 is not limited, but is practically about 10 μm because it is difficult to prepare the fine powder 112 when the D50 of the fine powder 112 is too small.

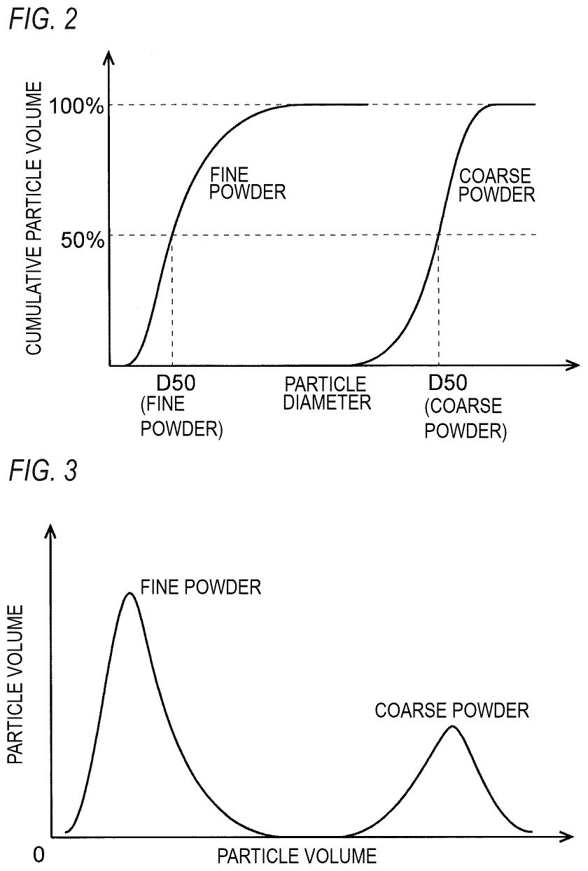

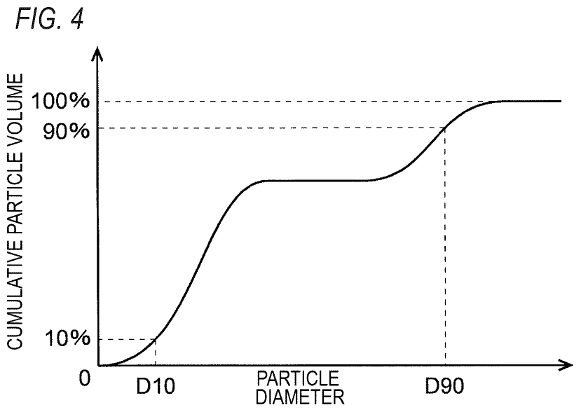

The coarse powder 111 and the fine powder 112 are mixed such that D90/D10 in the particle size distribution of the rare-earth magnet powder 11 after mixing is 28 or more and 37 or less. D90/D10 is preferably 28 or more and 36 or less, and more preferably 28 or more and 35 or less. Here, D90 refers to a particle diameter at which the cumulative distribution is 90%, D10 refers to a particle diameter at which the cumulative distribution is 10%, and D90/D10 refers to a value obtained by dividing D90 by D10, that is, D90/D10 corresponds to a ratio of D90 to D10. For example, in the case where the rare-earth magnet powder 11 is obtained by mixing the coarse powder 111 and the fine powder 112 each having the distribution of the volume (which is proportional to weight) of the particles relating to the particle diameter shown in the graph of FIG. 3, the rare-earth magnet powder 11 has a cumulative distribution shown in the graph of FIG. 4. In the graph of the cumulative distribution, the horizontal axis indicates the particle diameter and the vertical axis indicates the cumulative particle volume that is proportional to weight, the particle diameter when the cumulative particle volume is 90% is D90, and the particle diameter when the cumulative particle volume is 10% is D10.

When the rare-earth bonded magnet is produced using the compound 10 obtained as described above, the compound 10 is heated to a temperature higher than the melting point of the binder 12 and then injected into a mold 92 by an injection molding device 91 (FIG. 1D), and an inside of the mold 92 is cooled to a temperature lower than the melting point of the binder 12, thereby curing the binder 12. Accordingly, a rare-earth bonded magnet is obtained.

Next, experimental results relating to the compound 10 of the present embodiment which was actually prepared will be described. In this experiment, a SmFeN-based powder was used as the rare-earth magnet powder 11. A plurality of types of coarse powders 111 having a D50 within the range of 240 μm or more and less than 380 μm and a fine powder 112 having a D50 of 23 μm or 35 μm were prepared by pulverizing an alloy ribbon prepared by a molten metal quenching method. The rare-earth magnet powder 11 was obtained by mixing the coarse powder 111 and the fine powder 112 at a ratio described below. As the binder 12, three types of binders made of PPS and having different melting points, different viscosity during melting, and the like were prepared. The physical properties of the three types of the binders 12 (referred to as “PPS 1”, “PPS 2”, and “PPS 3”) are shown in Table 1. “MFR” in Table 1 is an abbreviation of “Melt Flow Rate”, and is a parameter representing the flowability of a resin. The MFR was measured according to ASTM D1238-90 under the conditions of a measurement temperature of 315° C., a measurement load of 49 N (5 kgf), and a holding time of 5 minutes.

TABLE 1

| | | Specific | | | Crystallization | | Average |
|---|---|---|---|---|---|---|---|
| | Manufacturer/ | gravity | MFR | Viscosity | temperature | Melting point | molecular |
| | product number | (g/cm³) | (g/10 min) | (Pa · s) | (° C.) | (° C.) | weight |
| PPS 1 | DIC Corporation/ | 1.35 | 2550 | 12 | 214 | 283 | 22000 |
| | H-1G | | | | | | |
| PPS 2 | DIC Corporation/ | 1.35 | 2090 | 15 | 218 | 280 | 23000 |
| | MA-501 | | | | | | |
| PPS 3 | DIC Corporation/ | 1.35 | 3250 | 10 | 203 | 283 | 20000 |
| | B-100-C | | | | | | |

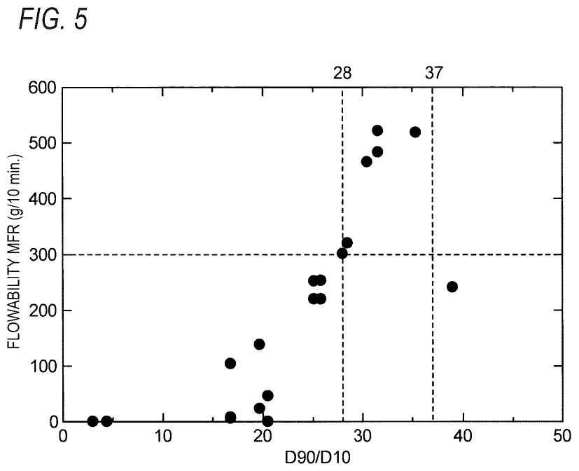

The compounds 10 obtained by kneading the rare-earth magnet powders 11 and the binders 12 were prepared under a plurality of conditions in which the values of the D50 of the coarse powders 111 and the fine powders 112, the blending ratios of the coarse powder 111 and the fine powder 112, and the type of the binders 12 were different, and the flowability of the compound 10 at 310° C. was measured. The blending ratio of the rare-earth magnet powder 11 and the binder 12 was 87.4:12.6 in mass ratio in all the examples and comparative examples. The preparation conditions and the measurement results of flowability are shown in Table 2, and the measurement results are also shown in the graph of FIG. 5. “Flowability MFR” in Table 2 is a parameter representing the flowability of a compound. The Flowability MFR of a compound was measured according to JIS K7210: 1999 under the conditions of a measurement temperature of 310° C., a measurement load of 980 N (100 kgf), a die diameter of 1 mm, and a die length of 2 mm. Further, CFT-500D manufactured by Shimadzu Corporation was used as a device for measuring the Flowability MFR. In Table 2, Examples 1 to 6 satisfy the requirement that D90/D10 of the rare-earth magnet powder 11 in the compound according to the present invention is 28 or more and 37 or less, and Comparative Examples 1 to 14 do not satisfy the requirement.

TABLE 2

| | Rare earth magnet powder | | | | | |
|---|---|---|---|---|---|---|
| | Coarse | Fine | | | | |
| | powder | powder | Blending | | | Compound |
| | D50 | D50 | ratio | | Binder | Flowability MFR |
| | (μm) | (μm) | (mass %) | D90/D10 | Material type | (g/10 min) |
| Example 1 | 261 | 23 | 30:70 | 35.4 | PPS 1 | 518 |
| Example 2 | 360 | 23 | 30:70 | 31.6 | PPS 2 | 483 |
| Example 3 | 360 | 23 | 30:70 | 31.6 | PPS 3 | 521 |
| Example 4 | 261 | 35 | 30:70 | 28.5 | PPS 1 | 320 |
| Example 5 | 261 | 35 | 30:70 | 30.5 | PPS 3 | 465 |
| Example 6 | 240 | 23 | 30:70 | 28.0 | PPS 1 | 301 |
| Comparative | *Note | 35 | 0:100 | 3.0 | PPS 1 | 0 |
| Example 1 | | | | | | |
| Comparative | 255 | 35 | 75:25 | 4.4 | PPS 1 | 0 |
| Example 2 | | | | | | |
| Comparative | 380 | 23 | 30:70 | 39.0 | PPS 1 | 241 |
| Example 3 | | | | | | |
| Comparative | 225 | 35 | 50:50 | 16.8 | PPS 1 | 8 |
| Example 4 | | | | | | |
| Comparative | 261 | 35 | 50:50 | 19.7 | PPS 1 | 23 |
| Example 5 | | | | | | |
| Comparative | 261 | 35 | 40:60 | 20.5 | PPS 1 | 0 |
| Example 6 | | | | | | |
| Comparative | 261 | 35 | 25:75 | 25.8 | PPS 1 | 253 |
| Example 7 | | | | | | |
| Comparative | 225 | 35 | 50:50 | 16.8 | PPS 2 | 6 |
| Example 8 | | | | | | |
| Comparative | 261 | 35 | 50:50 | 19.7 | PPS 2 | 138 |
| Example 9 | | | | | | |
| Comparative | 261 | 35 | 40:60 | 20.5 | PPS 2 | 46 |
| Example 10 | | | | | | |
| Comparative | 261 | 35 | 25:75 | 25.8 | PPS 2 | 220 |
| Example 11 | | | | | | |
| Comparative | 360 | 35 | 30:70 | 25.1 | PPS 2 | 252 |
| Example 12 | | | | | | |
| Comparative | 261 | 35 | 50:50 | 16.8 | PPS 3 | 104 |
| Example 13 | | | | | | |
| Comparative | 360 | 35 | 30:70 | 25.1 | PPS 3 | 220 |
| Example 14 | | | | | | |

*Note:
only fine powder was used in Comparative Example 1

In Examples 1 to 6, the MFR, which is a parameter indicating flowability, has a high value of 300 or more. In contrast, in Comparative Examples 1 to 14, the MFR is less than 300. The flowability of the binder 12 does not significantly affect the flowability of the compound 10 within the range (2090 to 3250) of flowability of the binder 12 used in this experiment. Therefore, it is considered that the flowability of the compound 10 is mainly affected by the characteristics of the rare-earth magnet powder 11, particularly, D90/D10. When the MFR is 300 or more as in Examples 1 to 6, the compound 10 can be spread over the entire mold during injection molding even in the case where a bonded magnet having a complicated shape is prepared. Therefore, the bonded magnet can be produced with a high degree of freedom.

Although the embodiments of the rare-earth bonded magnet compound according to the present invention and the method for producing a rare-earth bonded magnet using the compound have been described above, the present invention is not limited to these embodiments, and various modifications can be made within the scope of the gist of the present invention.

It is apparent to those skilled in the art that the embodiments described above are specific examples of the following aspects (1) to (6).
(1) A rare-earth bonded magnet compound, the compound including:
a rare-earth magnet powder that includes a coarse powder and a fine powder; and
a resin binder,
in which the rare-earth bonded magnet compound is obtained by kneading the rare-earth magnet powder and the resin binder,
the rare-earth magnet powder is obtained by mixing the coarse powder and the fine powder,
   the coarse powder has a D50 of 240 μm or more and less than 380 μm,
the fine powder has a D50 of 35 μm or less, and
the rare-earth magnet powder has a D90/D10, which is a ratio of D90 to D10 in a particle size distribution of the entire rare-earth magnet powder, of 28 or more and 37 or less.
(2) The rare-earth bonded magnet compound according to (1), in which the rare-earth magnet powder is made of a SmFeN-based material.
(3) The rare-earth bonded magnet compound according to (1) or (2), in which the rare-earth magnet powder is made of flat particles having a flat shape.
(4) The rare-earth bonded magnet compound according to any one of (1) to (3), in which the binder is made of a thermoplastic resin.
(5) The rare-earth bonded magnet compound according to any one of (1) to (4), in which the binder has a viscosity of 25 Pa·s or less at a temperature of 310° C.
(6) A method for producing a rare-earth bonded magnet, the method including:
preparing a rare-earth bonded magnet compound by kneading a rare-earth magnet powder and a binder, the rare-earth magnet powder being a mixture of a coarse powder having a D50 of 240 μm or more and less than 380 μm and a fine powder having a D50 of 35 μm or less, and the rare-earth magnet powder having a D90/D10, which is a ratio of D90 to D10 in a particle size distribution of the entire rare-earth magnet powder, of 28 or more and 37 or less; and
melting the binder kneaded into the rare-earth bonded magnet compound and then injecting the rare-earth bonded magnet compound into a mold.

The present application is based on Japanese Patent Applications No. 2023-173257 filed on Oct. 4, 2023 and No. 2024-117089 filed on Jul. 22, 2024, and the contents thereof are incorporated herein by reference.

### DESCRIPTION OF REFERENCE NUMERALS AND SIGNS

10 rare-earth bonded magnet compound (compound)
11 rare-earth magnet powder
111 rare earth magnet coarse powder (coarse powder)
112 rare earth magnet fine powder (fine powder)
12 binder
91 injection molding device
92 mold

What is claimed is:

1. A rare-earth bonded magnet compound, the compound comprising:
a rare-earth magnet powder that comprises a coarse powder and a fine powder; and
a resin binder,
wherein the rare-earth bonded magnet compound is obtained by kneading the rare-earth magnet powder and the resin binder,
the rare-earth magnet powder is obtained by mixing the coarse powder and the fine powder,
the coarse powder has a D50 of 240 μm or more and less than 380 μm,
the fine powder has a D50 of 35 μm or less, and
the rare-earth magnet powder has a D90/D10, which is a ratio of D90 to D10 in a particle size distribution of the entire rare-earth magnet powder, of 28 or more and 37 or less.

2. The rare-earth bonded magnet compound according to claim 1, wherein the rare-earth magnet powder is made of a SmFeN-based material.

3. The rare-earth bonded magnet compound according to claim 1, wherein the rare-earth magnet powder is made of flat particles having a flat shape.

4. The rare-earth bonded magnet compound according to claim 1, wherein the binder is made of a thermoplastic resin.

5. The rare-earth bonded magnet compound according to claim 1, wherein the binder has a viscosity of 25 Pa·s or less at a temperature of 310° C.

6. A method for producing a rare-earth bonded magnet, the method comprising:
preparing a rare-earth bonded magnet compound by kneading a rare-earth magnet powder and a binder, the rare-earth magnet powder being a mixture of a coarse powder having a D50 of 240 μm or more and less than 380 μm and a fine powder having a D50 of 35 μm or less, and the rare-earth magnet powder having a D90/D10, which is a ratio of D90 to D10 in a particle size distribution of the entire rare-earth magnet powder, of 28 or more and 37 or less; and
melting the binder kneaded into the rare-earth bonded magnet compound and then injecting the rare-earth bonded magnet compound into a mold.
